(19) United States
(12) Patent Application Publication
(10) Pub. No.: US 2009/0185281 A1
(43) Pub. Date: Jul. 23, 2009

(54) ZOOM OPTICAL SYSTEM, AND CAMERA AND DEVICE THEREWITH

(75) Inventor: Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/373,083

(22) PCT Filed: Jul. 2, 2007
(86) PCT No.: PCT/IB2007/052561

§ 371 Date: Jan. 9, 2009

(30) Foreign Application Priority Data
Jul. 13, 2006 (EP) 06117109.6

(51) Int. Cl. G02B 15/177; G02B 3/14

(52) U.S. Cl. 359/666

(57) ABSTRACT

The invention provides a zoom optical system comprising two fluid lenses (22, 40) and a first fixed lens group (20) of negative optical power, positioned at the object side of the zoom optical system. The first negative lens (20) ensures that a beam in the zoom optical system is relatively narrow, which allows the further elements, in particular the fluid lenses (22, 40) to be smaller in diameter, which is advantageous for their optical quality and for their susceptibility to temperature differences, gravitational influences et cetera.

### FIELD OF THE INVENTION

The present invention relates to a zoom optical system, having, as seen from an object side of the zoom optical system, a first fixed lens group, and an adjustable fluid lens group, wherein the adjustable lens group comprises at least a first and a second adjustable fluid lens, and a lens stop positioned between the first and second fluid lens.

The invention also relates to a camera device comprising such a zoom optical system, and to an image capturing device comprising such a camera.

### BACKGROUND OF THE INVENTION

A conventional zoom lens comprises a number of solid lens elements in groups, wherein a number of lens elements are moveable with respect to each other for performing zooming and focussing. In order to avoid moving lens elements, zoom lenses that use lens elements with an adjustable optical power have been developed.

Document WO2004/038480 discloses a zoom lens comprising a first fixed lens group, a second fixed lens group and a fluid lens group. The fluid lenses serve to zoom and focus the zoom lens.

This known zoom lens has a disadvantage that its optical quality is not satisfactory in many circumstances, such as varying temperature, and also under the influence of gravity.

### OBJECT OF THE INVENTION

It is an object of the invention to provide a zoom lens of the kind indicated in the preamble, which has an improved quality, in particular under varying temperatures, and which is less susceptible to gravitational influences.

### SUMMARY OF THE INVENTION

The object is achieved with a zoom optical system having, as seen from an object side of the zoom optical system, a first fixed lens group, and an adjustable fluid lens group, wherein the adjustable lens group comprises at least a first and a second adjustable fluid lens, and a lens stop positioned between the first and second fluid lens, characterized in that the first fixed lens group has a negative optical power K.

By providing that the first lens group has a negative optical power, it is easily possible to obtain a relatively narrow beam of light in the zoom lens even for a large angle of view. This in turn means that the average angle of incidence of light on the lenses in the zoom optical system is relatively small, which is advantageous for the optical performance, and it also means that all the following lenses, as seen in the direction away from the object, can be made smaller in diameter. Hence also the fluid lenses may have a small diameter, which is favourable for their optical quality, since fluid lenses with smaller diameter may contain less fluid, and are less susceptible to gravitational influences and temperature differences, which may cause differences in density. Furthermore, the possibility to provide a more compact zoomlens is by itself also an advantage. This advantage may be used for camera's and other devices, as will be elucidated below.

The lens stop is positioned between the first and second fluid lens for a number of reasons. Such a lens stop may for example be a plate or sheet with a fixed and often circular hole. Alternatively, it may also be an adjustable diaphragm, as is known from e.g. photography. First of all, generally, a lens stop will improve the optical quality by cutting off marginal rays, which suffer from more aberrations than central rays. Furthermore, the position between the two fluid lenses is triggered by the wish to position the stop and both fluid lenses relatively close to each other, since in that case the beam diameter at the position of the fluid lenses is relatively small. This is advantageous for the optical quality that can be achieved with the fluid lenses and the zoom optical system as a whole. Moreover, positioning the fluid lenses relatively far away from each other is advantageous for the optical power change and performance of the zoom optical system. In all, a position of the lens stop between the first and second fluid lens is preferred, because in that case a good compromise between the above criteria is obtained.

In particular, the optical power K is related to an optical power S of the zoom optical system according to |K|>0.1 |S|. The optical power is, as is usual, the reciprocal of the focal length. Although the advantages according to the invention may be present in general for every negative optical power of the first lens group, the inventor has found that for the indicated optical power the advantages become clear and useful.

In a special embodiment, the optical power K is related to the optical power S according to |K|>0.5 |S|. For such negative optical power, the design becomes much more compact, with a much improved optical quality.

It is noted that, in the context of the present application, the optical power of a lens or lens system that is non-spherical is taken at the centre, i.e. almost always along the optical axis, of the lens or lens system. It is furthermore noted that the optical system according to the invention is a zoom optical system, and the optical power of this system is taken to be its maximum optical power, i.e. in its ‘wide angle’ configuration.

The zoom optical system according to the invention comprises two fluid lenses. This allows for both the zoom function and the focusing function to be performed by the fluid lenses. This ensures that the system is in principle free from moving parts, which has advantageous as to useful life, maintenance and so on. Of course, ‘moving’ herein relates to shifting in physical space, such as translating or rotating, and not to changing a shape. It is furthermore possible to provide more than two fluid lenses, e.g. in order to distribute the zoom and/or focusing action over more than two lenses, which ensures that the relative change of shape is less pronounced.

In an embodiment, the first fixed lens group comprises a single negative lens. This provides a very simple yet effective lens system design. It is of course possible to provide a first fixed lens group with more than one lens, which may be advantageous in order to suppress lens aberrations. In such case, it is possible to provide a group with both negative and positive lens elements, or even zero-power elements, as long as the total optical power of the first lens group is negative, and preferably according to the relationship indicated above.

In an embodiment, at least the first fluid lens comprises at least one voltage controlled electrowetting device. In particular, at least one electrowetting device comprises an electrowetting cell that comprises a first fluid and a second fluid with a first fluid-second fluid interface therebetween. This is a common, simple and effective controllable fluid lens, though not the only possible one, alternatives being for example a resilient and transparent container with a fluid connection to a fluid reservoir, to or from which fluid may be pumped with a pump. However, the electrowetting device has an advantage that it needs no pump but simply a voltage control device, which is simpler and more reliable, and the container has a fixed shape and is more robust, with a much lower risk of leaking.

In a special embodiment, at least one electrowetting device comprises an electrowetting cell with two first fluid-second fluid interfaces. Such a cell, or fluid lens, has more degrees of freedom, and may thus provide better optical properties to the system.

In an embodiment, a lens of the first fixed lens group is integral with a wall of one of the at least one electrowetting cell. In a particular embodiment, the single negative lens is integral with a wall of one of the at least one electrowetting cell. In both cases, the design of the optical system becomes somewhat simpler, since a separate wall for the cell is no longer required, as its function is taken over by the lens, in particular the single negative lens. Note however that in this case there is no air or other gas between the lens and the fluid lens, which means that the optical properties change more or less drastically. In particular the optical power is in most cases reduced, both for the lens that is the wall of the cell, and for the fluid lens. Nevertheless, in cases in which the required optical power is not too high, this simple design may provide advantages as to cost, reliability and so on.

In this context, special and explicit reference is made to document WO2004/038480, which discloses on its page 5 and the description of FIGS. 1 and 2, of page 7-9, further details of the construction of electrowetting cells in general. This description is only partly copied here, and a number of the mentioned features will be used here, while the skilled person is understood to use the knowledge disclosed in the referenced document.

In a special embodiment, the lens stop is positioned symmetrically between the first fluid lens and the second fluid lens. This ensures that the maximum distance between the first and second fluid lens on the one hand, and the lens stop on the other hand, is a minimum, while at the same time the distance between the two fluid lenses may be made relatively large in a still compact design. This large mutual distance is advantageous for the optical power change and performance of the zoom optical system. Furthermore, a symmetrical design allows designs with less aberrations.

In a particular embodiment, the zoom optical system further comprises a second fixed lens group positioned, as seen from an object side of the zoom optical system, after the second fluid lens. Providing a second fixed lens group allows designs with even further improved optical quality, especially in the case of a more or less symmetrical design. However, the second fixed lens group will not often have a negative optical power like the first fixed lens group. It is furthermore possible to provide even more fixed lenses, such as between the first and second fluid lenses, or to provide more than two fluid lenses, all in order to further improve or change the optical properties of the zoom optical system, such as zoom range, optical quality or speed of the lens system.

The zoom optical system may further comprise at least one folding mirror, which advantageously serve to ‘fold’ the beam of light, thus enabling a design which is more compact with respect to the original direction of the light. This may be useful in various handheld devices, such as cameras, mobile cameraphones, webcams, et cetera.

The invention further relates to a camera device, comprising a zoom optical system according to the invention, and a light sensitive device positioned opposite the object side. The light sensitive device may for example be a photographic film, a ccd, an array of photodiodes, and so on. The camera according to the invention may further comprise other parts, such as a control device for controlling a lens stop, a zoom function and/or the light sensitive device, a power source, et cetera. Note that a control unit to provide a zoom and/or focusing action may also be provided with the zoom optical system.

The invention also relates to an image capturing device comprising a camera device according to the invention. In particular, the image capturing device comprises a mobile phone, a webcam, a personal digital assistant or an endoscope. Of course, other image capturing devices are possible as well, but especially those mentioned here profit from the advantages of the zoom optical system according to the invention, especially its compact design with a small diameter.

### BRIEF DESCRIPTION OF THE DRAWINGS

FIG. 1 diagrammatically show a cross-section of a prior art fluid lens;

FIG. 2 diagrammatically shows a zoom optical system according to the invention;

FIG. 3 diagrammatically shows another embodiment of the zoom optical system according to the invention;

FIG. 4 diagrammatically shows an embodiment of a camera according to the invention;

FIGS. 5a and b show a number of paths of light through the zoom optical system of FIG. 2, and

FIGS. 6a, b show the polychromatic modulation transfer function of the system of FIG. 2, 5 for TELE and WIDE, respectively.

### DETAILED DESCRIPTION OF EXAMPLES

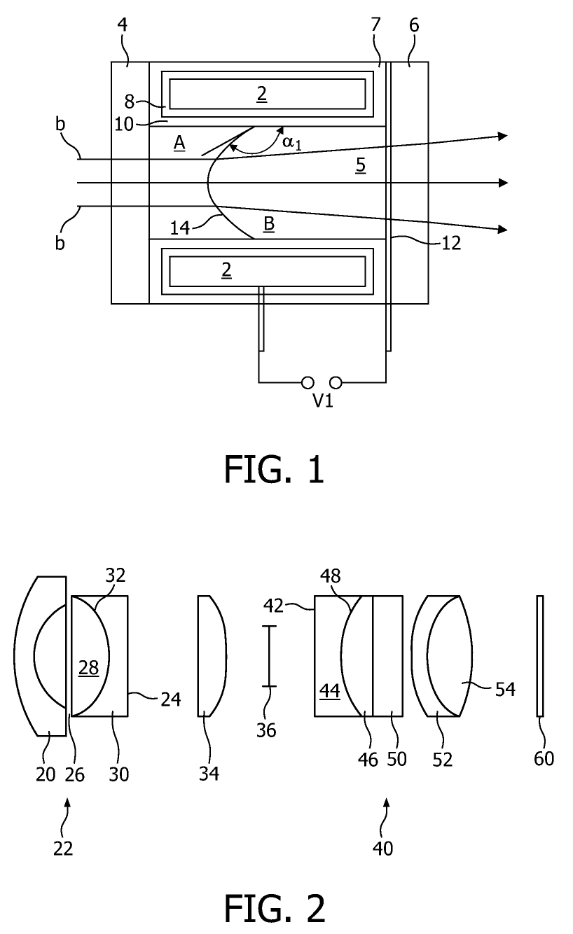

FIG. 1 diagrammatically show a cross-section of a prior art fluid lens. The lens comprises a cylindrical first electrode 2 forming a capillary tube, sealed by means of a transparent front element 4 and a transparent back element 6 to form a fluid chamber 5 containing two fluids. The electrode 2 may be a conducting coating applied on the inner wall of a tube 7.

In this fluid lens, the two fluids consist of two non-miscible liquids in the form of an electrically insulating first liquid A, such as a silicone oil or an alkane, referred to herein further as “the oil”, and an electrically conducting second liquid B, such as an aqueous salt solution. The two liquids are preferably arranged so as to have equal densities so that the lens functions independently of orientation, i.e. without dependence on gravitational effects between the two liquids. This may be achieved by an appropriate choice of the first liquid constituent; for example alkanes or silicone oils may be modified by addition of molecular constituents to increase their density to match that of the salt solution. Note that, according to the invention as e.g. embodied in the other Figures, smaller fluid lenses allow better density matching in more circumstances, such as a wider temperature range.

Depending on the choice of the oil used, the refractive index of the oil may vary between 1.25 and 1.60. Likewise, dependent on the amount of salt added, the salt solution may vary in refractive index between 1.33 and 1.48. The fluids in this embodiment are selected such that the first fluid A has a higher refractive index than the second fluid B.

The first electrode 2 is a cylinder of inner radius typically between 1 mm and 20 mm. The electrode 2 is formed from a metallic material and is coated with an insulating layer 8, for example of parylene. The insulating layer has a thickness of between 50 nm and 100 μm, with typical values lying between 1 μm and 10 μm.

The insulating layer 8 is coated with a fluid contact layer 10 which reduces the hysteresis in the contact angle of the meniscus with the cylindrical wall of the fluid chamber. The fluid contact layer is preferably formed from an amorphous fluorocarbon such as Teflon™ AF1600 produced by DuPont™. The fluid contact layer 10 has a thickness of between 5 nm and 50 μm. The AF1600 coating may be produced by repeated dip coating of the electrode 2. A homogeneous layer of material of substantially uniform thickness is formed thereby since the cylindrical sides of the electrode are substantially parallel to the cylindrical electrode. Dip coating is performed by dipping the electrode whilst moving the electrode into and out of the dipping solution along its axial direction. The parylene coating may be applied by chemical vapor deposition. The wettability of the fluid contact layer 10 by the second fluid is substantially equal on both sides of the intersection of the meniscus 14 with the contact layer 10 when no voltage is applied between the first and the second electrode.

A second, annular electrode 12 is arranged at one end of the fluid chamber, in this case adjacent the back element 6. At least a portion of the second electrode is arranged in the fluid chamber such that the electrode acts on the second fluid B.

The two fluids A and B are non-miscible so that they tend to separate into two fluid bodies with a meniscus 14 in between. When no voltage is applied between the first and second electrode 2 and 12, the fluid contact layer has a higher wettability with respect to the first fluid A than the second fluid B. Due to electrowetting, the wettability by the second fluid B varies upon application of a voltage between the first electrode and the second electrode, which tends to change the contact angle of the meniscus at the three-phase line.

The three-phase line is the line of contact between the fluid contact layer 10 and the two liquids A and B. The shape of the meniscus is thus variable in dependence on the applied voltage. The meniscus between the first fluid and the second fluid is called concave if the meniscus is hollow as seen from the fluid having the higher refractive index. If this fluid is regarded as a lens, this lens would normally be called concave if the meniscus is concave according to the definition in the previous sentence.

Referring now to FIG. 1, when a low voltage V₁, e.g. between 0 V and 20 V, is applied between the electrodes, the meniscus adopts a first concave meniscus shape. In this configuration, the initial contact angle α₁ between the meniscus and the fluid contact layer 10 measured in the fluid B is, for example, approximately 140°. Since the first fluid A has a higher refractive index than the second fluid B, the lens formed by the meniscus, here called meniscus lens, has a relatively high negative power in this configuration. A collimated beam b passing through the lens 1 becomes strongly diverged.

To reduce the concavity of the meniscus shape, a higher voltage may be applied between the first and second electrodes. For example, when an intermediate voltage V₂, e.g. 20 V to 150 V, depending on the thickness of the insulating layer 8, is applied between the electrodes, the meniscus adopts a second concave meniscus shape having a radius of curvature increased in comparison with the meniscus in FIG. 1. In this configuration an intermediate contact angle α₂ (not shown) between the first fluid A and the fluid contact layer 10 is, for example, 100°. Since the first fluid A has a higher refractive index than the second fluid B, the meniscus lens in this configuration has a relatively low negative power. The collimated beam b becomes weakly diverged.

To produce a convex meniscus shape, a yet higher voltage may be applied between the first and second electrodes. For example, when a relatively high voltage V3, e.g. 150 to 200 V, is applied between the electrodes, the meniscus adopts a convex shape. In this configuration, the maximum contact angle α₃ (not shown) between the first fluid A and the contact layer 10 is, for example, approximately 600. Since the first fluid A has a higher refractive index than the second fluid B, the meniscus lens in this configuration has a positive power. The lens converts the collimated beam b into a converged beam.

Note that it is preferred in a practical embodiment that a device comprising the fluid lens as described is adapted to use only low and intermediate voltages in the ranges described. That is to say that the voltage applied is restricted such that the electric field strength in the insulating layer is smaller than 20V/μm, and excessive voltages causing charging of the fluid contact layer, and hence degradation of the fluid contact layer, are not used.

Note furthermore that the initial, low-voltage configuration will vary in dependence on the selection of the fluids (liquids) A and B, in dependence on their surface tensions. By selecting oil with a higher surface tension, and/or by adding a component, such as ethylene glycol, to the salt solution, which reduces its surface tension, the initial contact angle can be decreased. In any case, the lower power configuration remains such that the meniscus is concave, and a relatively wide range of lens powers can be produced without using an excessive voltage.

Although in the above example the fluid A has a higher refractive index than fluid B, the fluid A may also have a lower refractive index than fluid B. For example, the fluid A may be a (per)fluorinated oil, which has a lower refractive index than water. In this case the amorphous fluoropolymer layer is preferably not used, because it may dissolve in fluorinated oils. An alternative fluid contact layer is e.g. a paraffin coating.

FIG. 2 diagrammatically shows a zoom optical system according to the invention.

Herein, 20 is a first negative lens, and 22 and 40 are two fluid lenses, with first fluids 28 and 44, respectively, with second fluids 30 and 46, respectively, and a meniscus or fluid interface 32 and 48, respectively.

24, 42 is a first, second housing, while 26, 50 may be e.g. protective windows. An additional lens 34 is positioned before a lens stop 36. Additional lenses 52 and 56 are positioned before a screen 60.

The first lens 20 has a negative optical power, preferably a significant negative optical power, i.e. with an absolute value of at least about 10% of the total system's optical power. The lens 20 is shown as a single lens, although a two-part or even more complicated lens is also possible, as long as the total lens group has a negative optical power.

The fluid lenses 22 and 40 generally correspond to the fluid lens electrowetting cell of FIG. 1, with housings and fluids with intermediate meniscus. Not shown are voltage sources between the relevant electrodes (shown neither) in the cells. What is shown, however, are additional lens elements 34, 52 and 54, which may serve to provide better optical performance, or e.g. a more desirable range of focal lengths. Furthermore, a lens stop 36 is provided, generally at the smallest diameter part of a beam of light through the optical system, and it often serves to improve optical quality by cutting off the most aberration loaded marginal rays of the beam. The lens stop may have a fixed diameter, or may be an adjustable diaphragm or the like.

Note that there are two fluid lenses, which allows both zooming, i.e. changing a focal length in order to make a field of view larger or smaller, and also focusing, i.e. ensuring that a sharp image is provided at a desired location, in this case a screen 60, which is optional, e.g. in a camera. To be very precise, because in this case there are no moving parts, focusing comes down to selecting the optical powers of both fluid lenses such that a sharp image is produced on the screen 60. However, this focusing action only has a small influence on the total optical power.

The screen 60, which is optional, may be a light sensitive film, a ccd, et cetera. It may serve to capture an image as seen by the zoom optical system.

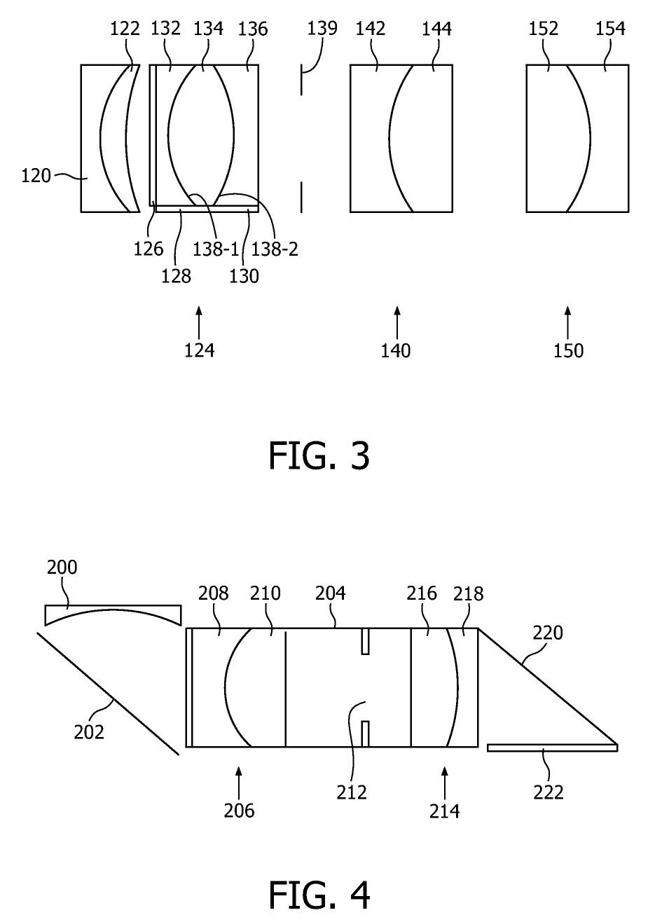

FIG. 3 diagrammatically shows another embodiment of the zoom optical system according to the invention.

Herein, the first fixed lens group comprises lenses 120 and 122. Also present are fluid lenses 124, 140 and 150, and a lens stop 139. Fluid lens 124 comprises a front element 126, a first electrode part 128 and a second electrode part 130, and contains a first fluid 132, a second fluid 134 and a third fluid 136, with menisci 138-1 and 138-2 therebetween. The second and third fluid lenses 140 and 150 each contain a first fluid 142, 152 and a second fluid 144, 154.

Here, the first fixed lens group comprises more than one lens element, and its total optical power is negative. This may be useful in order to improve optical quality, especially since the diameter of the lens elements is rather large. Note that in this and the other figures, the diameter of all but the first lens elements could have been made smaller, in order to achieve an advantage according to the invention. However, for clarity of the drawings, this has not been drawn.

The first fluid lens contains a first, second and third fluid, with two menisci. The three fluids may be different, but it is also possible to have the first and third fluids taken the same. It is also possible to take the first fluid as a fixed lens element. Since it is indicated with a negative optical power, this means that elements 120 and 122 could also be omitted, while being an embodiment according to the invention. However, the optical power would decrease, because there would be a transition from e.g. the glass of element 132 to fluid, instead of the transition from glass of elements 120, 122 to air, and from air to fluid 132. Furthermore, it is advantageous to have two menisci in the first fluid lens, in order to have more design freedom, especially since there are two more menisci, in lenses 140 and 150. This ensures that the fluid lenses need not each have extreme optical powers, or be changed dramatically, such that electrical powers and voltages may remain low.

The lens stop 139 is positioned between two fluid lenses 124 and 140, preferably in a position where the beam will have its smallest diameter. Another criterion may be the distance between the lens stop and the fluid lenses, and the mutual distance between the fluid lenses. The skilled person will then select an optimum compromise.

To control the three fluids in fluid lens 124, voltages may be applied between front element 126 and first electrode part 128, and between first electrode part 126 and second electrode part 128, in each case according to known techniques. The same holds similarly for the fluid 142, 144, 152 and 154 of the other fluid lenses.

The embodiment shown has a high versatility, with a relatively low power consumption, and low control voltages.

FIG. 4 diagrammatically shows an embodiment of a camera according to the invention. It comprises a first lens element 200, a first folding mirror 202, and a housing 204 with a first and second fluid lens 206 and 214, with first fluids 208, 216, and second fluids 210, 218. Also indicated is a lens stop 212, as well as a second folding mirror 220 and a screen 222. The folding mirrors may also be curved, hence adding optical power to the optical system.

The main difference with the embodiment shown in FIG. 3 is the presence of two folding mirrors 202 and 220, which allow redirection of the path of the beam. For example, the camera may comprise an overall housing which is like a flat box, with side walls generally parallel to the two side walls of the housing 204 as indicated in the drawing. In such case, the first element 200 and the screen 222 are then also parallel to the side walls. The two folding mirrors then allow the beam to run parallel to the side walls as well, for the larger part of the length. This clearly allows a flat camera, which is desirable.

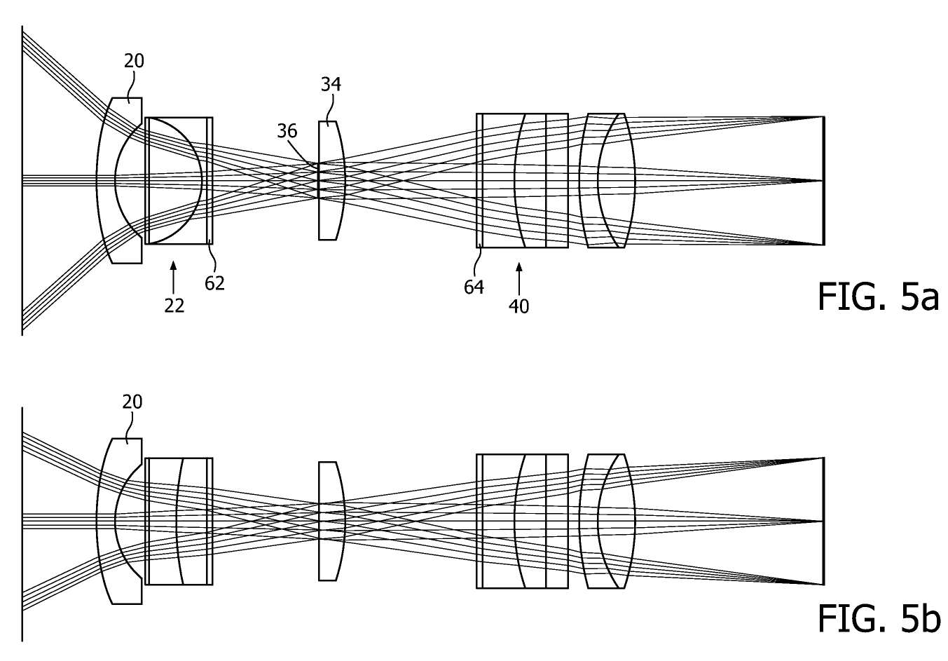

FIGS. 5a and b show a number of paths of light through the zoom optical system of FIG. 2, in a wide angle setting (5a) and a tele setting (5b).

Also shown is a lens stop 36, positioned on a face of the additional lens 34, hence positioned approximately symmetrically between fluid lenses 22 and 40. For the sake of completeness, also indicated are two platelets 62 and 64 that close off the fluid in the fluid lenses. It is clearly visible that the fluid lenses have different menisci in the ‘wide’ and ‘tele’ settings. It is also clearly visible that the beams of light are rather narrow after the first lens element, while still allowing a large filed of view (a wide angle) and while still the angles of incidence of the rays in the beam and onto the various optical parts are rather small. All this ensures a good optical quality, under various conditions, such as varying temperature, shocks etc.

The embodiment shown here is a 1.6× zoom lens, and has a fixed negative lens 20 with a focal length f=−3.09 mm. Hence, the optical power is K=−0.324 mm⁻¹. The focal length of the lens system in the wide configuration is 2.088 mm, hence the total optical power S=0.479 mm⁻¹. Hence K and S clearly satisfy the relationship |K|>0.5 |S|.

As said above, the zoom optical system according to the invention has a relatively narrow beam path. This gives relatively good optical properties, but may also lead in some cases to a relatively large length of the system. This is however not a problem in many cases, such as an endoscope or the like, and it may also be counteracted with folding mirrors such as those in FIG. 4. In most cases, the gain in optical quality, and the smaller diameter of the optical system according to the invention will be the most important advantages.

In the table below, the lens data of the embodiment of FIG. 5 are given.

TABLE 1
Lens surface data

| | | thick- | | | |
|---|---|---|---|---|---|
| | radius | ness | diameter | | |
| Surface | [mm] | [mm] | [mm] | n_{d}, V_{d} | Comment |
| Object plane | — | — | — | — | |
| 1 | 7.580 | 0.5 | 4.2 | 1.8106, 40.9 | aspherical |
| 2 | 1.820 | 0.811 | 2.9 | | |
| 3 | ∞ | 0.1 | 2.62 | 1.517, 64.2 | |
| 4 | ∞ | D1 | 3.2 | 1.330, 56.4 | |
| 1^{st} meniscus | R1 | D2 | 3.2 | 1.520, 50.9 | adjustable |
| 6 | ∞ | 0.2 | 3.2 | 1.517, 64.2 | |
| 7 | ∞ | 2.8 | 3.2 | | |
| Lens stop | ∞ | 0.03 | 0.88 | | |
| 9 | ∞ | 0.7 | 3 | 1.806, 40.9 | |
| 10 | −4.595 | 3.5 | 3 | | |
| 11 | ∞ | 0.2 | 3.4 | 1.517, 64.2 | |
| 12 | ∞ | D3 | 3.4 | 1.330, 56.4 | |
| 2^{nd} meniscus | R2 | D4 | 3.4 | 1.522, 50.9 | adjustable |
| 14 | ∞ | 0.6 | 3.4 | 1.518, 74.6 | |
| 15 | ∞ | 0.3 | 3.4 | | |
| 16 | 6.393 | 0.5 | 3.4 | 1.923, 18.9 | |
| 17 | 2.839 | 1 | 3.4 | 1.517, 52.4 | |
| 18 | −5.030 | 5.07 | 3.4 | | |
| 19 | ∞ | 0.03 | 3.3 | | |
| Image plane | — | — | (3.3) | | |

Herein, the following settings hold for the two extreme zoom angles. The fields of view and focal lengths are 80° and 2.088 mm (so S=0.479 mm⁻¹) for ‘wide’, and 50° and 3.474 mm (so S=0.287 mm⁻¹) for tele, respectively.

The first lens is an aspherical lens. This is not necessary, but provides the possibility to correct better for spherical and other aberrations. In this case, the lens sutface is described as a polynomial expansion of the deviation from a spherical surface. The even asphere surface model uses only the even powers of the radial coordinate to describe the asphericity. The surface sag in this particular lens case is given by

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} .$$

### Wherein

z is the surface sag in millimeters,
r is the radial coordinate in millimeters,
c is the curvature=1/radius=0.132 mm⁻¹,
k=conical constant (k=0 in this case),
α₁=0 mm⁻¹,
α₃=0.0049762 mm⁻³,
α₅=0.0005190 mm⁻⁵

Furthermore, since the fluid lenses have a fixed volume, the thickness will be a function of curvature. For the extreme radii, i.e. tele and wide, the numbers are given in the table below.

TABLE 2
Data on the menisci in ‘tele’ and ‘wide’

| | R1 | D1 | D2 | R2 | D3 | D4 |
|---|---|---|---|---|---|---|
| zoom | [mm] | [mm] | [mm] | [mm] | [mm] | [mm] |
| wide | −1.627 | 1.431 | 0.119 | 4.746 | 0.840 | 0.860 |
| tele | 6.537 | 0.725 | 0.825 | −7.936 | 1.265 | 0.435 |

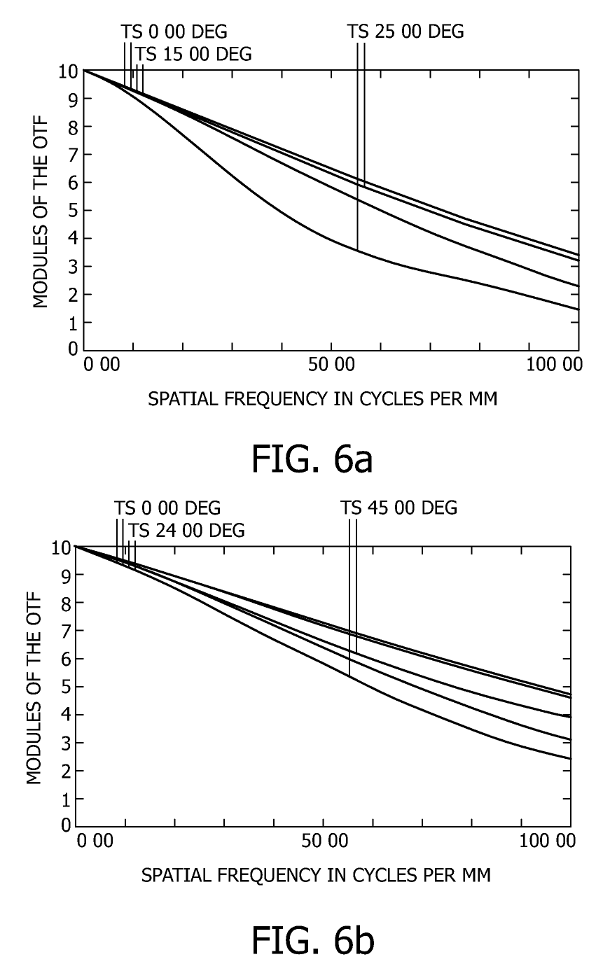

With the embodiment of the zoom optical system according to FIG. 5 and Tables 1 and 2, some optical properties are as given in FIGS. 6a, b.

FIG. 6a shows the polychromatic modulation transfer function for the TELE configuration at 0°, 15° and 25° field, and FIG. 6b shows the polychromatic modulation transfer function for the WIDE configuration at 0°, 24° and 40° field. Shown are the tangential (“T”) and sagittal (“S”) curves, averaged over wavelengths from 435.8 to 656.3 nm, as a function of the spatial frequency. It can be seen that the curves for (0°, S), (0°, T) and (15°, S) for TELE largely coincide. Furthermore, what is more important, the MTF is in most cases more than sufficient to provide a satisfactory resolving power. For example, when a VGA chip is used as the sensor to detect the image with pixel size of 3 μm. Hence the maximum resolving power will be 166 cycles/mm. In practice, it is sufficient if at about ⅓ of this maximum resolving power, i.e. at 50 cycles/mm, the MTF is at least 0.5 on axis and at least 0.4 off axis. As can be seen in FIGS. 6a and b, this is the case for all shown fields of the WIDE setting, also and for all fields of the TELE setting. This shows that a good optical quality can be reached with this type of zoom lens, which has no moving parts, and which may be made very compact.

The embodiments described above are not intended to be limiting, but are only provided to facilitate an understanding of the invention. The features of the embodiments may be taken in any desired combination, unless indicated to the contrary. Furthermore, the skilled person will be able to modify the invention within the scope of the invention, which is to be determined by the appended claims.

1. A zoom optical system having, as seen from an object side of the zoom optical system, a first fixed lens group (20; 120, 122; 200), and an adjustable fluid lens group (22, 40; 124, 140, 150; 206, 214), wherein the adjustable lens group comprises at least a first (22; 124; 206) and a second (40; 140, 150; 214) adjustable fluid lens, and a lens stop (36; 139; 212) positioned between the first and second fluid lens,
characterized in that the first fixed lens (20; 120, 122; 200) group has a negative optical power K.

2. A zoom optical system according to claim 1, wherein the optical power K is related to an optical power S of the zoom optical system according to

|K|>0.1|S|.

3. A zoom optical device according to claim 1, wherein the optical power K is related to the optical power S according to:

|K|>0.5|S|.

4. A zoom optical device according to claim 1, wherein the first fixed lens group (20; 120, 122; 200) comprises a single negative lens (20; 200).

5. A zoom optical device according to claim 1, wherein at least the first fluid lens (22; 124; 206) comprises at least one voltage controlled electrowetting device.

6. A zoom optical device according to claim 5, wherein at least one electrowetting device comprises an electrowetting cell that comprises a first fluid (28, 44; 132, 142, 152; 208, 216) and a second fluid (30, 46; 134, 144, 154; 210, 218) with a first fluid-second fluid interface (32, 48; 138-1, 138-2) therebetween.

7. A zoom optical device according to claim 5, wherein at least one electrowetting device comprises an electrowetting cell (124) with two first fluid-second fluid interfaces (138-1, 138-2).

8. A zoom optical device according to claim 6, wherein a lens of the first fixed lens group (20; 120, 122; 200) is integral with a wall of one of the at least one electrowetting cell.

9. A zoom optical device according to claim 4, wherein the single negative lens (20; 200) is integral with a wall of one of the at least one electrowetting cell.

10. A zoom optical device according to claim 1, wherein the lens stop (36; 139; 212) is positioned symmetrically between the first fluid lens (22; 206) and the second fluid lens (40; 214).

11. A zoom optical device according to claim 1, further comprising a second fixed lens group (52, 54) positioned, as seen from an object side of the zoom optical system, after the second fluid lens (40).

12. A zoom optical device according to claim 1, further comprising at least one folding mirror (202, 220).

13. A camera device, comprising a zoom optical system according to claim 1, and a light sensitive device (60; 222) positioned opposite the object side.

14. An image capturing device comprising a camera device according to claim 13.

15. An image capturing device according to claim 14, wherein the image capturing device comprises a mobile phone, a webcam, a personal digital assistant or an endoscope.
